(19) United States
(12) Patent Application Publication
(10) Pub. No.: US 2025/0299119 A1
(43) Pub. Date: Sep. 25, 2025

(54) INFORMATION PROCESSING APPARATUS, METHOD, AND SYSTEM

(71) Applicant: TOYOTA JIDOSHA KABUSHIKI KAISHA, Toyota-shi Aichi-ken (JP)

(72) Inventors: Koji UEDA, Funabashi-shi Chiba-ken (JP); Ibuki SHIMADA, Miyoshi-shi Aichi-ken (JP); Kazuhiro UMEDA, Mitaka-shi Tokyo-to (JP); Katsuhiro WATANABE, Kawasaki-shi Kanagawa-ken (JP)

(73) Assignee: TOYOTA JIDOSHA KABUSHIKI KAISHA, Toyota-shi Aichi-ken (JP)

(21) Appl. No.: 19/083,827

(22) Filed: Mar. 19, 2025

(30) Foreign Application Priority Data
Mar. 22, 2024 (JP) 2024-046959

(51) Int. Cl. G06Q 10/0631; G06Q 50/40

(52) U.S. Cl. CPC G06Q 10/06311; G06Q 50/40

(57) ABSTRACT

An information processing apparatus configured to manage an operation plan for one or more automated driving vehicles includes a database configured to store one or more users, the one or more automated driving vehicles, one or more operation diagrams, and one or more locations on a route in each of the one or more operation diagrams, in association with information on at least one area. The information processing apparatus then displays, for each of the one or more users, one or more operation diagrams associated with information on at least one area associated with the user, on a built-in display or a screen of an external device.

### CROSS-REFERENCE TO RELATED APPLICATION

This application claims priority to Japanese Patent Application No. 2024-046959 filed on Mar. 22, 2024, the entire contents of which are incorporated herein by reference.

### TECHNICAL FIELD

The present disclosure relates to an information processing apparatus, a method, and a system.

### BACKGROUND

Operation management systems that manage operation plans for automated driving vehicles are conventionally known. For example, Patent Literature (PTL) 1 discloses that, when an automated driving vehicle is affected by a roadway obstacle, an operation management system automatically outputs, based on images of the roadway obstacle to a road management system, an instruction to remove the roadway obstacle.

### CITATION LIST

### Patent Literature

PTL 1: JP 2022-058001 A

### SUMMARY

There is room for improvement with respect to technology of operation management systems that manage operation plans for automated driving vehicles.

It would be helpful to improve technology of operation management systems that manage operation plans for automated driving vehicles.

An information processing apparatus according to an embodiment of the present disclosure includes:
a memory including a database configured to store one or more users, one or more automated driving vehicles, one or more operation diagrams, and one or more locations on a route in each of the one or more operation diagrams, in association with at least one area; and
a controller configured to display, for each of the one or more users, one or more operation diagrams associated with at least one area associated with the user, on a built-in display or a screen of an external device.

A method according to an embodiment of the present disclosure is a method performed by an information processing apparatus configured to manage an operation plan for one or more automated driving vehicles, the method including:
storing, in a database, one or more users, the one or more automated driving vehicles, one or more operation diagrams, and one or more locations on a route in each of the one or more operation diagrams, in association with at least one area; and
displaying, for each of the one or more users, one or more operation diagrams associated with at least one area associated with the user, on a built-in display or a screen of an external device.

A system according to an embodiment of the present disclosure is a system configured to manage an operation plan for one or more automated driving vehicles, the system including:
an information processing apparatus; and
a terminal apparatus,
wherein
the information processing apparatus includes a database configured to store one or more users, the one or more automated driving vehicles, one or more operation diagrams, and one or more locations on a route in each of the one or more operation diagrams, in association with at least one area, and
the information processing apparatus or the terminal apparatus is configured to display, on a screen, for each of the one or more users, one or more operation diagrams associated with at least one area associated with the user.

According to an embodiment of the present disclosure, technology of operation management systems that manage operation plans for automated driving vehicles is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of a terminal apparatus;

FIG. 3 is a block diagram illustrating a schematic configuration of a vehicle;

FIG. 4 is a block diagram illustrating a schematic configuration of an information processing apparatus;

FIG. 5 is an example ⅓ of a DB configuration image of the information processing apparatus according to the embodiment;

FIG. 6 is an example ⅔ of the DB configuration image of the information processing apparatus according to the embodiment; and

FIG. 7 is an example 3/3 of the DB configuration image of the information processing apparatus according to the embodiment.

### DETAILED DESCRIPTION

Hereinafter, an embodiment of the present disclosure will be described.

### Outline of Embodiment

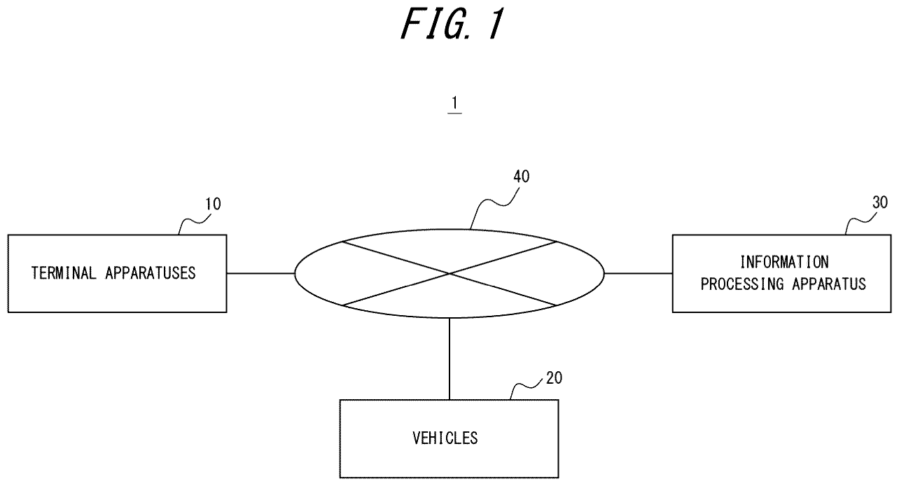

An outline of a system 1 according to the embodiment of the present disclosure will be described with reference to FIG. 1. The system 1 includes a plurality of terminal apparatuses 10, a plurality of vehicles 20, and an information processing apparatus 30. The terminal apparatuses 10, the vehicles 20, and the information processing apparatus 30 are communicably connected to a network 40 including, for example, the Internet, a mobile communication network, and the like.

The terminal apparatuses 10 are computers, such as personal computers (PCs), smartphones, or tablet terminals. In the present embodiment, the terminal apparatuses 10 are used by users who manage operations of automated driving vehicles, and are connected to the information processing apparatus 30 via the network 40 to input and output information necessary to manage the operations of the automated driving vehicles.

The vehicles 20 may be automated driving vehicles capable of automated driving such as any one of Level 1 to Level 5 as defined by the Society of Automotive Engineers (SAE), for example. In the present embodiment, the vehicles 20 are capable of automated driving at Level 3 or 4, and driving assistants can override driving operations on board the vehicles 20 or remotely. The system 1 may include any number of one or more vehicles 20.

The information processing apparatus 30 is one computer or a plurality of computers, e.g., server apparatuses, that can communicate with each other. The information processing apparatus 30 can communicate with each terminal apparatus 10 and each vehicle 20 via the network 40.

First, an outline of the present embodiment will be described, and details thereof will be described later. The information processing apparatus 30, which manages operation plans for one or more automated driving vehicles, includes a database configured to store one or more users, the one or more automated driving vehicles, one or more operation diagrams, and one or more locations on a route in each of the one or more operation diagrams, in association with information on at least one area. The information processing apparatus 30 then displays, for each of the one or more users, one or more operation diagrams associated with information on at least one area associated with the user, on a built-in display or a screen of an external device.

A conventional operation management system for automated driving vehicles manages operations in a range that satisfies an operational design domain (ODD) registered in the operation management system. However, the automated driving vehicles, in contrast to conventional vehicles, have a wide variety of factors required to manage the operations, which may require much time and effort to manage the operations and may increase the probability of occurrence of errors. Under these circumstances, according to the present embodiment, the automated driving vehicles, the users, the operation diagrams, and the locations are managed in a unit called area, instead of being managed in a range of operations that satisfy the operational design domain (ODD). This increases the probability of reducing a mistake that, for example, an operation manager in charge of an area erroneously assigns an automated driving vehicle that does not satisfy the ODD, as a service scheduled to travel in that area. It also allows for more efficient operation, such as making changes to operation plans on an area-by-area basis. Therefore, the present embodiment improves technology for operation management systems that manage operations of automated driving vehicles, in that the operations of the automated driving vehicles can be managed accurately and efficiently.

Next, configurations of the system 1 will be described in detail.

### Configuration of Terminal Apparatus

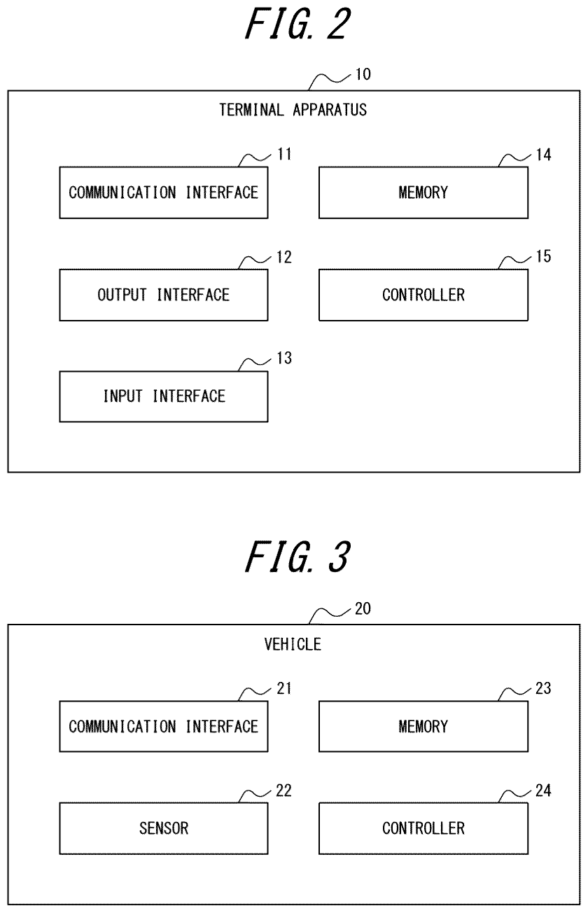

As illustrated in FIG. 2, each terminal apparatus 10 includes a communication interface 11, an output interface 12, an input interface 13, a memory 14, and a controller 15.

The communication interface 11 includes at least one communication interface for connecting to the network 40. The communication interface is compliant with a mobile communication standard such as the 4th generation (4G) standard or the 5th generation (5G) standard, for example, but is not limited to these. In the present embodiment, the terminal apparatus 10 communicates with the vehicles 20 and the information processing apparatus 30 via the communication interface 11 and the network 40.

The output interface 12 includes at least one output device for outputting information. The output device is, for example, a display for outputting information as video, a speaker for outputting information as audio, or the like, but is not limited to these. Alternatively, the output interface 12 may include an interface for connecting to an external output device.

The input interface 13 includes at least one input device for detecting an input operation by a user. The input device is, for example, a physical key, a capacitive key, a mouse, a touch panel, a touch screen integrally provided with a display of the output interface 12, a microphone, or the like, but is not limited to these. Alternatively, the input interface 13 may include an interface for connecting to an external input device.

The memory 14 includes one or more memories. The memories are, for example, semiconductor memories, magnetic memories, optical memories, or the like, but are not limited to these. The memories included in the memory 14 may each function as, for example, a main memory, an auxiliary memory, or a cache memory. The memory 14 stores any information to be used for operations of the terminal apparatus 10. The memory 14 may store driving record information acquired from the vehicles 20. For example, the memory 14 may store a system program, an application program, embedded software, or the like. The information stored in the memory 14 may be updated with, for example, information acquired from the network 40 via the communication interface 11.

The controller 15 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 15 controls operations of the entire terminal apparatus 10.

### Configuration of Vehicle

As illustrated in FIG. 3, each vehicle 20 includes a communication interface 21, a sensor 22, a memory 23, and a controller 24.

The communication interface 21 includes at least one communication interface for connecting to the network 40. The communication interface is compliant with mobile communication standards such as the 4th generation (4G) standard and the 5th generation (5G) standard, for example, but not limited to these, and may be compliant with any communication standard. In the present embodiment, the vehicle 20 communicates with the information processing apparatus 30 via the communication interface 21 and the network 40.

The sensor 22 includes one or more sensors for use in control of the vehicle 20. The sensors include, for example, a position sensor corresponding to a global positioning system (GPS) or the like, a geomagnetic sensor, a velocity sensor, an acceleration sensor, a gyro sensor, or the like, but are not limited to these and may include any sensor.

The memory 23 includes one or more memories. In the present embodiment, the “memories” are semiconductor memories, magnetic memories, optical memories, or the like, for example, but are not limited to these. The memories included in the memory 23 may each function as, for example, a main memory, an auxiliary memory, or a cache memory. The memory 23 stores any information to be used for operations of the vehicle 20. For example, the memory 23 may store a system program, an application program, embedded software, or the like. The information stored in the memory 23 may be updated with, for example, information acquired from the network 40 via the communication interface 21.

The controller 24 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 24 controls operations of the entire vehicle 20.

### Configuration of Information Processing Apparatus

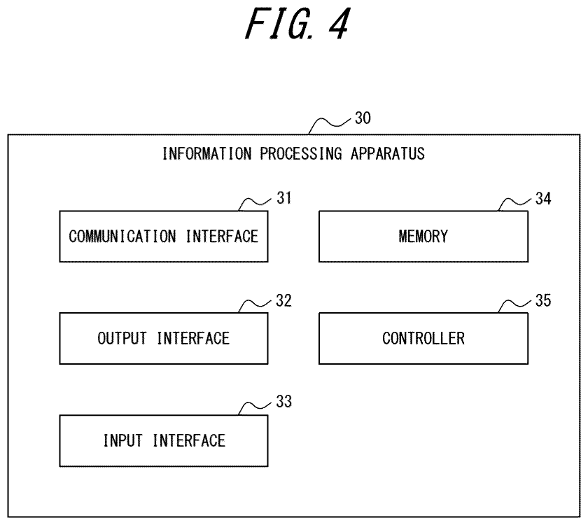

As illustrated in FIG. 4, the information processing apparatus 30 includes a communication interface 31, an output interface 32, an input interface 33, a memory 34, and a controller 35.

The communication interface 31 includes at least one communication interface for connecting to the network 40. The communication interface is compliant with a wired LAN standard or a wireless LAN standard, for example, but is not limited to these, and may be compliant with any communication standard. In the present embodiment, the information processing apparatus 30 communicates with the terminal apparatuses 10 and the vehicles 20 via the communication interface 31 and the network 40.

The output interface 32 includes at least one output device for outputting information. The output device is, for example, a display for outputting information as video, a speaker for outputting information as audio, or the like, but is not limited to these. Alternatively, the output interface 32 may include an interface for connecting to an external output device.

The input interface 33 includes at least one input device for detecting an input operation by a user. The input device is, for example, a physical key, a capacitive key, a mouse, a touch panel, a touch screen integrally provided with a display of the output interface 32, a microphone, or the like, but is not limited to these. Alternatively, the input interface 33 may include an interface for connecting to an external input device.

The memory 34 includes one or more memories. The memories included in the memory 34 may each function as, for example, a main memory, an auxiliary memory, or a cache memory. The memory 34 stores any information to be used for operations of the information processing apparatus 30. For example, the memory 34 may store a system program, an application program, embedded software, map information, and the like. In the present embodiment, the memory 34 is provided with a database (DB) 300 that stores information to be used for managing operations of automated driving vehicles.

The controller 35 includes at least one processor, at least one programmable circuit, at least one dedicated circuit, or a combination of these. The controller 35 controls operations of the entire information processing apparatus 30. Details of the operations of the information processing apparatus 30 will be described below.

### DB Structure of Information Processing Apparatus

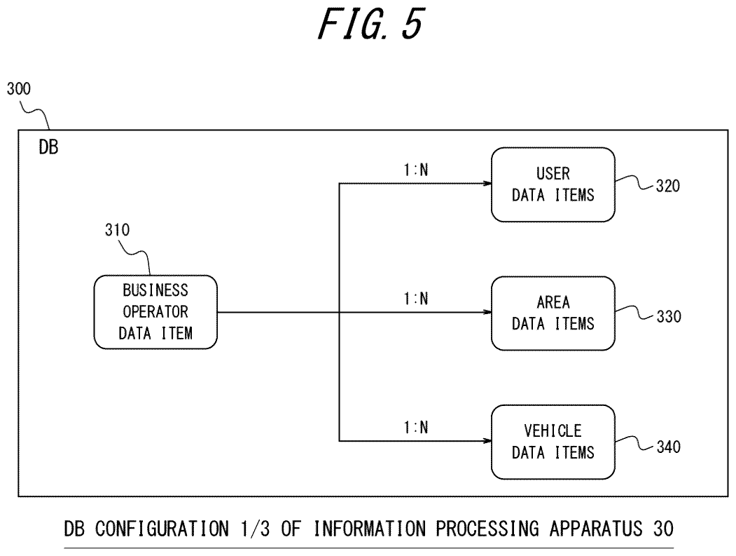

As illustrated in FIGS. 5, 6, and 7, the DB 300 of the information processing apparatus 30 includes a business operator data item 310, user data items 320, area data items 330, vehicle data items 340, operation diagram data items 350, and location data items 360. The DB 300 may also include service data items 370, operation date data items 380, and passage time data items 390.

The business operator data item 310 is information on a business operator to which users of an operation management system, which manages operations of automated driving vehicles, provided by the information processing apparatus 30 belong. For example, the business operator data item 310 may include a business operator ID to uniquely identify the business operator. As illustrated in FIG. 5, in the present embodiment, the business operator data item 310 is configured to be associated with one or more user data items 320, one or more area data items 330, and one or more vehicle data items 340.

Specifically, for example, the business operator data item 310 may include one or more user IDs contained in the one or more user data items 320, one or more area IDs contained in the one or more area data items 330, and one or more vehicle IDs contained in the one or more vehicle data items 340.

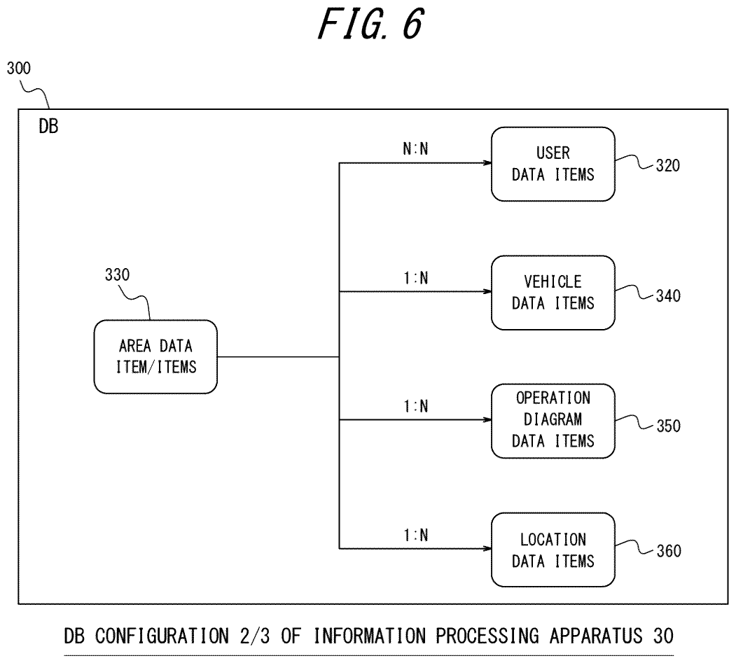

The user data items 320 are information on the users of the operation management system, who use the information processing apparatus 30 and the terminal apparatuses 10. For example, each user data item 320 may include a user ID to uniquely identify a user. As illustrated in FIGS. 5 and 6, in the present embodiment, each user data item 320 is configured to be necessarily associated with the one business operator data item 310, and be associated with one or more area data items 330.

Specifically, for example, each user data item 320 may include the business operator ID contained in the one business operator data item 310 and one or more area IDs contained in the one or more area data items 330.

The area data items 330 are units for managing the operations of the automated driving vehicles. For example, each area data item 330 may include an area ID to uniquely identify an area. As illustrated in FIGS. 5 and 6, in the present embodiment, each area data item 330 is configured to be necessarily associated with the one business operator data item 310, and be associated with one or more user data items 320, one or more vehicle data items 340, one or more operation diagram data items 350, and one or more location data items 360.

Specifically, for example, each area data item 330 may include the business operator ID contained in the one business operator data item 310, one or more user IDs contained in the one or more user data items 320, one or more vehicle IDs contained in the one or more vehicle data items 340, one or more operation diagram IDs contained in the one or more operation diagram data items 350, and one or more location IDs contained in the one or more location data items 360. Since the area data items 330 are units for managing the operations of the automated driving vehicles, the real area indicated by an area data item 330 can overlap that indicated by another area data item 330. For example, when an area data item 330 includes a location of Address A, another area data item 330 may also include the location of Address A. Each area data item 330 may also include information on a range in which the operations of the automated driving vehicles are managed. Alternatively, each area data item 330 may include information on a compatible autonomous driving development kit (ADK). The information may be information on a plurality of compatible ADKs.

The vehicle data items 340 are information on the vehicles 20. For example, each vehicle data item 340 may include a vehicle ID to uniquely identify a vehicle 20. For example, each vehicle data item 340 may include information on the type of vehicle 20 and an ADK installed in the vehicle 20. As illustrated in FIGS. 5 and 6, in the present embodiment, each vehicle data item 340 is configured to be associated with the one business operator data item 310 and one area data item 330.

Specifically, for example, each vehicle data item 340 may include the business operator ID contained in the one business operator data item 310 and an area ID contained in the one area data item 330. Each vehicle data item 340 may include only the area ID contained in the one area data item 330. In this case, the vehicle data item 340 is configured to be associated with the one business operator data item 310 via the area data item 330.

The information processing apparatus 30 may receive, from the controller 24 of each vehicle 20, information on the type of vehicle 20 and the ADK installed in the vehicle 20, and store the information in a vehicle data item 340 corresponding to the vehicle 20.

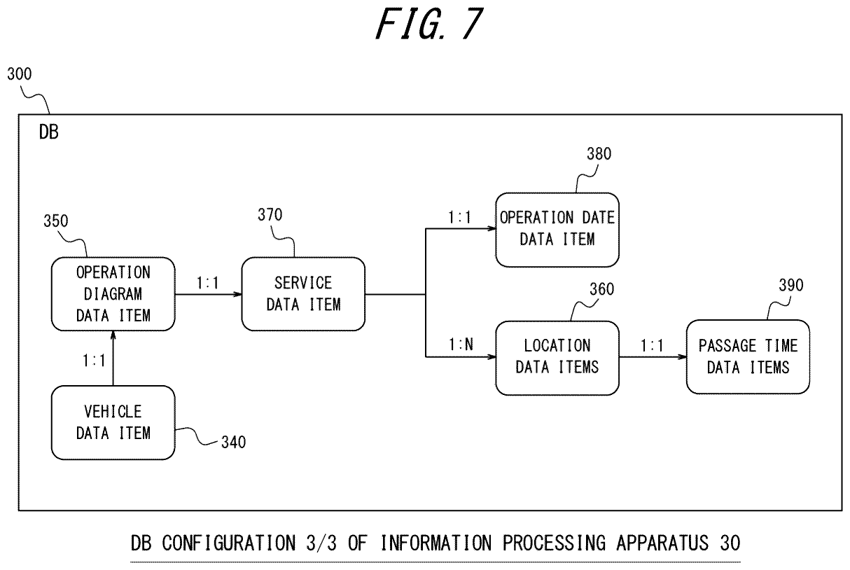

Each operation diagram data item 350 includes an operation start time, an operation end time, and route information of a service data item 370. For example, each operation diagram data item 350 may include an operation diagram ID to uniquely identify an operation diagram, and the operation start time, the operation end time, and the route information of the service data item 370. Note that, a method of calculating the operation start time and the operation end time of the service data item 370 and a method of identifying the route information are described below. As illustrated in FIG. 7, in the present embodiment, each operation diagram data item 350 is configured to be necessarily associated one-to-one with a service data item 370, be necessarily associated with one vehicle data item 340, and be associated with one or more location data items 360 and one or more operation date data items 380 via the one service data item 370.

Specifically, for example, each operation diagram data item 350 may include a service ID contained in the one service data item 370, a vehicle ID contained in the one vehicle data item 340, location IDs contained in the one or more location data items 360, and operation date IDs contained in the one or more operation date data items 380.

Alternatively, each operation diagram data item 350 may include all Information on the one service data item 370.

Each location data item 360 is information to uniquely identify a stop location of a service data item 370. For example, each location data item 360 may include a location ID to identify the location, and information such as an address indicating the location. Note that, location data items 360 are different between upbound and downbound of an operation system. As illustrated in FIGS. 6 and 7, in the present embodiment, each location data item 360 is configured to be necessarily associated with one area data item 330, and be associated with one or more service data items 370.

Specifically, for example, each location data item 360 may include an area ID contained in the one area data item 330. In the present embodiment, since each location data item 360 is necessarily associated with one area data item 330, the same stop location may be treated as different location data items 360 when being associated with different area data items 330. Each location data item 360 may also include information on a compatible ADK. The information may be information on a plurality of compatible ADKs.

Each service data item 370 is information to uniquely identify an operation system and a service in the operation system. For example, each service data item 370 may include a service ID, which combines an operation system ID with an ID identifying the service to uniquely identify the service, and an operation date data item 380. As illustrated in FIG. 7, in the present embodiment, each service data item 370 is configured to be associated with one or more location data items 360.

Specifically, for example, each service data item 370 may include location IDs contained in the one or more location data items 360. Each service data item 370 may also include information on the order in which the service data item 370 passes by each of the location data items 360, and passage time data items 390. Each service data item 370 may be associated with one vehicle data item 340, instead of an operation diagram data item 350, and may include the operation start time, the operation end time, and the route information of the service data item 370.

Each operation date data item 380 is information to identify a day on which the service data item 370 operates. An operation date contained in the operation date data item 380 may be represented by a specific month and day, by a date, or by a day of the week. Alternatively, the operation date data item 380 may be information that identifies a day on which the service does not operate. When the operation date is represented by a day of the week or a date, the operation date data item 380 may include data such as a flag that can determine whether the operation is repeated or one-time only.

Each passage time data item 390 is a time at which a service data item 370 passes by a location data item 360. Each passage time data item 390 may be represented by hours and minutes.

An operation start time, an operation end time, and route information of a service data item 370 are calculated or specified by the controller 35 of the information processing apparatus 30, and stored in the memory 34 as information on an operation diagram data item 350 or the service data item 370.

Specifically, the controller 35 calculates, as the operation start time, a passage time data item 390 of the fastest location data item 360 in the order of passage, out of location data items 360 included in the service data item 370, calculates, as the operation end time, a passage time data item 390 of the latest location data item 360 in the order of passage, out of the location data items 360 included in the service data item 370, and stores the calculated passage time data items 390 in the memory 34. The controller 35 also identifies the route information of the service data item 370 by arranging the location data items 360 included in the service data item 370 in the order of passage, and stores the identified route information in the memory 34.

### Details of Embodiment

Next, the details of the present embodiment will be described using an example of the DB 300 of the information processing apparatus 30 illustrated in FIG. 6.

As illustrated in FIG. 6 and described above, one or more user data items 320, one or more vehicle data items 340, one or more operation diagram data items 350, and one or more location data items 360 on a route in each of the one or more operation diagram data items 350, which are stored in the memory 34 of the information processing apparatus 30, are configured to be associated with at least one area.

When a user using the system 1 logs in and accesses the information processing apparatus 30, the controller 35 can identify one or more area data items 330 that the user manages, because a user data item 320 corresponding to the user is associated with the area data items 330. The controller 35 can then identify one or more operation diagram data items 350 associated with each of the identified one or more area data items 330. Therefore, the controller 35 can display only the identified one or more operation diagram data items 350 on a display of the output interface 32, or a screen of an external device such as a display of the output interface 12 of the terminal apparatus 10.

As described above, the information processing apparatus 30, which manages operation plans for one or more automated driving vehicles, includes a database configured to store one or more users, the one or more automated driving vehicles, one or more operation diagrams, and one or more locations on a route in each of the one or more operation diagrams, in association with information on at least one area. The information processing apparatus 30 then displays, for each of the one or more users, one or more operation diagrams associated with information on at least one area associated with the user, on a built-in display or a screen of an external device.

According to such a configuration, the automated driving vehicles, the users, the operation diagrams, and the locations are managed in a unit called area, rather than being managed in a range of operations that satisfy the operational design domain (ODD). This increases the probability of reducing a mistake that, for example, an operation manager in charge of an area erroneously assigns an automated driving vehicle that does not satisfy the ODD, as a service scheduled to travel in that area. It also allows for more efficient operation, such as making changes to operation plans on an area-by-area basis. Therefore, the present embodiment improves technology for operation management systems that manage operations of automated driving vehicles, in that the operations of the automated driving vehicles can be managed accurately and efficiently.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or a single component, step, or the like can be divided.

For example, an embodiment in which the configuration and operations of the terminal apparatus 10 and/or the information processing apparatus 30 in the above embodiment are distributed to multiple computers capable of communicating with each other can be implemented. For example, an embodiment in which some or all of the components of the information processing apparatus 30 are provided in the terminal apparatus 10 is also possible, and vice versa, an embodiment in which some or all of the components of the terminal apparatus 10 are provided in the information processing apparatus 30 is also possible. For example, the terminal apparatus 10 may have some or all of the components of the information processing apparatus 30, and the information processing apparatus 30 may have some or all of the components of the terminal apparatus 10.

For example, in the embodiment described above, the controller 35 may perform control so that a first automated driving vehicle associated with a first operation diagram cannot be associated with a second operation diagram that partially overlaps the first operation diagram in time period.

Specifically, consider a case in which, for example, a user assigns a vehicle data item 340 (first automated driving vehicle) to an operation diagram data item 350 (second operation diagram), on a management screen provided by the information processing apparatus 30. At this time, the controller 35 checks whether a period between an operation start time and an operation end time contained in the operation diagram data item 350 acquired from the memory 34 overlaps a period between an operation start time and an operation end time contained in another operation diagram data item 350 (first operation diagram) with which the vehicle data item 340 has already been associated. When there is no overlap, the controller 35 associates the vehicle data item 340 with the operation diagram data item 350. When there is an overlap, the controller 35 may output, to the management screen, a message of, for example, “This vehicle cannot be assigned because it has already been assigned to the “first operation diagram””, and perform control so that the vehicle data item 340 cannot be associated with the operation diagram data item 350. Alternatively, the controller 35 may output, to the management screen, a message of, for example, “Please change the vehicle in the “first operation diagram” because this vehicle has already been assigned to the “first operation diagram””, and unassociate the vehicle data item 340 associated with the other operation diagram data item 350 or encourage the user to unassociate the vehicle data item 340.

For example, in the embodiment described above, the controller 35 may limit, based on information on the ADKs in a vehicle data item 340, area data items 330 with which the vehicle data item 340 can be associated, or operation diagram data items 350 with which the automated driving vehicle can be associated.

Specifically, consider a case in which, for example, a user assigns a vehicle data item 340 to an area data item 330 or an operation diagram data item 350, on a management screen provided by the information processing apparatus 30. At this time, the controller 35 checks whether information on the ADK contained in the vehicle data item 340 is included in information on the compatible ADKs contained in the area data item 330. Alternatively, the controller 35 checks whether information on the ADK contained in the vehicle data item 340 is included in information on the compatible ADKs contained in each of all location data items 360 on the route of the operation diagram data item 350. When the information is included, the controller 35 associates the vehicle data item 340 with the area data item 330 or the operation diagram data item 350. When the vehicle data item 340 has already been assigned to another area data item 330 or another operation diagram data item 350, the controller 35 may transmit information required for settings on the ADK due to a change in area or operation diagram, to the vehicle 20 corresponding to the vehicle data item 340. When the information is not included, the controller 35 may output, to the management screen, a message of, for example, “This vehicle cannot be assigned because the ADK is not compatible with this area” or “This vehicle cannot be assigned because the ADK is not compatible with this operation diagram”, and perform control so that the vehicle data item 340 cannot be associated with the area data item 330 or the operation diagram data item 350. Alternatively, the controller 35 may output, to the management screen, a message of, for example, “Please change the settings on the ADK of the vehicle because the ADK of this vehicle is not compatible with this area”, and encourage the user to change the settings on the ADK installed in the vehicle 20.

For example, in the embodiment described above, the vehicle data items 340 may include information regarding the statuses of the vehicles 20 corresponding to the vehicle data items 340. The controller 35 may limit, based on the information regarding the statuses, area data items 330 with which each vehicle data item 340 can be associated, or operation diagram data items 350 with which each vehicle data item 340 can be associated.

Specifically, consider a case in which, for example, the vehicle data items 340 include information regarding the statuses of the vehicles 20, and a user assigns a vehicle data item 340 to an area data item 330 or an operation diagram data item 350 on a management screen provided by the information processing apparatus 30. At this time, the controller 35 checks the information regarding the status of the vehicle 20 contained in the vehicle data item 340. When, for example, the status of the vehicle 20 is “out of service”, the controller 35 may output, to the management screen, a message of, for example, “This vehicle is out of service and cannot be assigned”, and perform control so that the vehicle data item 340 cannot be associated with the area data item 330 or the operation diagram data item 350.

“The information regarding the status” includes the vehicle 20 being “out of service” as described above, but may also include any information regarding the vehicle 20, such as “in operation”, “in maintenance”, and the like.

For example, in the embodiment described above, the operation diagram data items 350 may include information on conditions of the routes of the operation diagrams, and the controller 35 may limit, based on the information on the conditions of the routes, operation diagram data items 350 with which vehicle data items 340 can be associated.

Specifically, consider a case in which, for example, the operation diagram data items 350 include information on conditions of the routes of the operation diagrams, and a user assigns a vehicle data item 340 to an area data item 330 or an operation diagram data item 350, on a management screen provided by the information processing apparatus 30. At this time, the controller 35 checks information on conditions of the route of the operation diagram contained in the operation diagram data item 350. When, for example, the conditions of the route of the operation diagram indicate “accident in progress”, the controller 35 may output a message of, for example, “This route cannot be assigned because an accident has occurred” to the management screen, and perform control so that the vehicle data item 340 cannot be associated with the operation diagram data item 350.

“The information on the conditions of the route of the operation diagram” includes the condition of “accident in progress” on the route of the operation diagram, as described above, but may also include any information on the conditions of the route of the operation diagram, such as “under construction,” “bad weather,” and the like. The controller 35 may acquire the information on the conditions of the route of the operation diagram by periodically receiving, from a system that monitors road conditions, information on road conditions on the route of the operation diagram.

For example, in the embodiment described above, the controller 35 may determine, based on an operation date data item 380 contained in a service data item 370, whether a service is temporary. When the service is temporary, the service may be displayed on a built-in display or a screen of an external device in such a manner as to indicate that the service is temporary.

Specifically, the controller 35 checks a flag, which is contained in the operation date data item 380, to determine whether the operation is repeated or one-time only. When the operation is one-time only, the controller 35 determines that the service corresponding to the service data item 370, which is associated one-to-one with an operation diagram data item 350, is temporary. The controller 35 then displays the service in such a manner as to indicate that the service is temporary, on a display of the output interface 32, or a screen of an external device such as a display of the output interface 12 of the terminal apparatus 10.

For example, “a manner as to indicate that the service is temporary” can be in any manner, such as using a different color only for the temporary service, or displaying that the service is temporary on the temporary service.

For example, in the embodiment described above, the controller 35 may limit, based on information on the compatible ADKs contained in location data items 360, the association of an operation diagram data item 350 with an area data item 330.

Specifically, consider a case in which, for example, a user changes assignment of an area data item 330, which is associated with an operation diagram data item 350, to another area data item 330, on a management screen provided by the information processing apparatus 30. At this time, the controller 35 checks, for every location data item 360 associated with the operation diagram data item 350, whether information on any of the compatible ADKs contained in the location data item 360 coincides with information on any of the compatible ADKs contained in the area data item 330 after the change. When the information coincides, the controller 35 associates the operation diagram data item 350 with the area data item 330 after the change. When the information does not coincide, the controller 35 may output, to the management screen, a massage of, for example, “This operation diagram cannot be assigned because the ADK is not compatible with the area after the change”, and perform control so that the operation diagram data item 350 cannot be associated with the area data item 330 after the change.

For example, in the embodiment described above, the controller 35 may limit, based on information on the compatible ADKs contained in a location data item 360, the association of the location data item 360 with an operation diagram data item 350.

Specifically, consider a case in which, for example, a user changes assignment of a location data item 360, which is associated with an operation diagram data item 350, to another location data item 360, on a management screen provided by the information processing apparatus 30. At this time, the controller 35 checks whether information on any of the compatible ADKs contained in other location data items 360 associated with the operation diagram data item 350 coincides with information on any of the compatible ADKs contained in the location data item 360 after the change. When the information coincides, the controller 35 associates the operation diagram data item 350 with the location data item 360 after the change. When the information does not coincide, the controller 35 may output, to the management screen, a massage of, for example, “This location cannot be assigned because the ADK is not compatible with the operation diagram”, and perform control so that the operation diagram data item 350 cannot be associated with the location data item 360 after the change.

For example, an embodiment in which a general purpose computer functions as the information processing apparatus 30 according to the above embodiment can also be implemented. Specifically, a program in which processes for realizing the functions of the information processing apparatus 30 according to the above embodiment are written may be stored in a memory of a general purpose computer, and the program may be read and executed by a processor. Accordingly, the present disclosure can also be implemented as a program executable by a processor, or a non-transitory computer readable medium storing the program.

Examples of some embodiments of the present disclosure are described below. However, it should be noted that the embodiments of the present disclosure are not limited to these examples.

[Appendix 1] An information processing apparatus configured to manage an operation plan for one or more automated driving vehicles, the information processing apparatus comprising:
a memory including a database configured to store one or more users, the one or more automated driving vehicles, one or more operation diagrams, and one or more locations on a route in each of the one or more operation diagrams, in association with at least one area; and
a controller configured to display, for each of the one or more users, one or more operation diagrams associated with at least one area associated with the user, on a built-in display or a screen of an external device.

[Appendix 2] The information processing apparatus according to appendix 1, wherein each of the one or more operation diagrams is stored in one-to-one association with one service.

[Appendix 3] The information processing apparatus according to appendix 2, wherein
information on each of the one or more operation diagrams includes an operation start time and an operation end time, and
the controller is configured to perform control so that a first automated driving vehicle associated with a first operation diagram cannot be associated with a second operation diagram that partially overlaps the first operation diagram in time period.
[Appendix 4] The information processing apparatus according to any one of appendices 1 to 3, wherein
information on each of the one or more automated driving vehicles includes information on an autonomous driving development kit (ADK) installed in each of the one or more automated driving vehicles, and
the controller is configured to limit, based on the information on the ADK, an area with which each of the one or more automated driving vehicles can be associated, or an operation diagram with which each of the one or more automated driving vehicles can be associated.

[Appendix 5] The information processing apparatus according to appendix 4, wherein the controller is configured to, when an area with which an automated driving vehicle is associated has been changed, output, to the built-in display or the screen of the external device, a message to encourage a change of a setting on the ADK of the automated driving vehicle.

[Appendix 6] The information processing apparatus according to any one of appendices 1 to 5, wherein
information on each of the one or more automated driving vehicles includes information on a status of each of the one or more automated driving vehicles, and
the controller is configured to limit, based on the information on the status, an area with which each of the one or more automated driving vehicles can be associated, or an operation diagram with which each of the one or more automated driving vehicles can be associated.

[Appendix 7] The information processing apparatus according to any one of appendices 1 to 6, wherein
information on each of the one or more operation diagrams includes information on a condition of the route of each of the one or more operation diagrams, and
the controller is configured to limit, based on the information on the condition of the route, an operation diagram with which each of the one or more automated driving vehicles can be associated.

[Appendix 8] The information processing apparatus according to any one of appendices 2 to 7, wherein the controller is configured to:
determine, based on information on an operation date contained in information on the one service, whether the one service is temporary; and
when the one service is determined as being temporary, display, on the built-in display or the screen of the external device, the one service in such a manner as to indicate that the one service is temporary.

[Appendix 9] The information processing apparatus according to any one of appendices 4 to 8, wherein
information on each of the one or more locations includes information on an autonomous driving development kit (ADK) compatible with each of the one or more locations, and
the controller is configured to limit, based on the information on the ADK, an area with which each of the one or more operation diagrams can be associated.

[Appendix 10] The information processing apparatus according to any one of appendices 4 to 8, wherein
information on each of the one or more locations includes information on an autonomous driving development kit (ADK) compatible with each of the one or more locations, and
the controller is configured to limit, based on the information on the ADK, arrangement of each of the one or more locations on a route of an operation diagram.

[Appendix 11] A method performed by an information processing apparatus configured to manage an operation plan for one or more automated driving vehicles, the method comprising:
storing, in a database, one or more users, the one or more automated driving vehicles, one or more operation diagrams, and one or more locations on a route in each of the one or more operation diagrams, in association with at least one area; and
displaying, for each of the one or more users, one or more operation diagrams associated with at least one area associated with the user, on a built-in display or a screen of an external device.

[Appendix 12] The method according to appendix 11, further comprising:
storing each of the one or more operation diagrams in one-to-one association with one service, information on each of the one or more operation diagrams including an operation start time and an operation end time; and
performing control so that a first automated driving vehicle associated with a first operation diagram cannot be associated with a second operation diagram that partially overlaps the first operation diagram in time period.

[Appendix 13] The method according to appendix 11 or 12, wherein
information on each of the one or more automated driving vehicles includes information on an autonomous driving development kit (ADK) installed in each of the one or more automated driving vehicles, and
the method further comprises limiting, based on the information on the ADK, an area with which each of the one or more automated driving vehicles can be associated, or an operation diagram with which each of the one or more automated driving vehicles can be associated.

[Appendix 14] The method according to appendix 13, further comprising, when an area with which an automated driving vehicle is associated has been changed, outputting, to the built-in display or the screen of the external device, a message to encourage a change of a setting on the ADK of the automated driving vehicle.

[Appendix 15] The method according to any one of appendices 11 to 14, wherein
information on each of the one or more automated driving vehicles includes information on a status of each of the one or more automated driving vehicles, and
the method comprises limiting, based on the information on the status, an area with which each of the one or more automated driving vehicles can be associated, or an operation diagram with which each of the one or more automated driving vehicles can be associated.

[Appendix 16] The method according to any one of appendices 11 to 15, wherein
information on each of the one or more operation diagrams includes information on a condition of the route of each of the one or more operation diagrams, and
the method further comprises limiting, based on the information on the condition of the route, an operation diagram with which each of the one or more automated driving vehicles can be associated.

[Appendix 17] The method according to any one of appendices 11 to 16, further comprising:
storing each of the one or more operation diagrams in one-to-one association with one service;
determining, based on information on an operation date contained in information on the one service, whether the one service is temporary; and
when the one service is determined as being temporary, displaying, on the built-in display or the screen of the external device, the one service in such a manner as to indicate that the one service is temporary.

[Appendix 18] The method according to any one of appendices 13 to 17, wherein
information on each of the one or more locations includes information on an autonomous driving development kit (ADK) compatible with each of the one or more locations, and
the method further comprises limiting, based on the information on the ADK, an area with which each of the one or more operation diagrams can be associated.

[Appendix 19] The method according to any one of appendices 13 to 18, wherein
information on each of the one or more locations includes information on an autonomous driving development kit (ADK) compatible with each of the one or more locations, and
the method further comprises limiting, based on the information on the ADK, arrangement of each of the one or more locations on a route of an operation diagram.

[Appendix 20] A system configured to manage an operation plan for one or more automated driving vehicles, the system comprising:
an information processing apparatus; and
a terminal apparatus,
wherein
the information processing apparatus includes a database configured to store one or more users, the one or more automated driving vehicles, one or more operation diagrams, and one or more locations on a route in each of the one or more operation diagrams, in association with at least one area, and
the information processing apparatus or the terminal apparatus is configured to display, on a screen, for each of the one or more users, one or more operation diagrams associated with at least one area associated with the user.

1. An information processing apparatus configured to manage an operation plan for one or more automated driving vehicles, the information processing apparatus comprising:
a memory including a database configured to store one or more users, the one or more automated driving vehicles, one or more operation diagrams, and one or more locations on a route in each of the one or more operation diagrams, in association with at least one area; and
a controller configured to display, for each of the one or more users, one or more operation diagrams associated with at least one area associated with the user, on a built-in display or a screen of an external device.

2. The information processing apparatus according to claim 1, wherein each of the one or more operation diagrams is stored in one-to-one association with one service.

3. The information processing apparatus according to claim 2, wherein
information on each of the one or more operation diagrams includes an operation start time and an operation end time, and
the controller is configured to perform control so that a first automated driving vehicle associated with a first operation diagram cannot be associated with a second operation diagram that partially overlaps the first operation diagram in time period.

4. The information processing apparatus according to claim 1, wherein
information on each of the one or more automated driving vehicles includes information on an autonomous driving development kit (ADK) installed in each of the one or more automated driving vehicles, and
the controller is configured to limit, based on the information on the ADK, an area with which each of the one or more automated driving vehicles can be associated, or an operation diagram with which each of the one or more automated driving vehicles can be associated.

5. The information processing apparatus according to claim 4, wherein the controller is configured to, when an area with which an automated driving vehicle is associated has been changed, output, to the built-in display or the screen of the external device, a message to encourage a change of a setting on the ADK of the automated driving vehicle.

6. The information processing apparatus according to claim 1, wherein
information on each of the one or more automated driving vehicles includes information on a status of each of the one or more automated driving vehicles, and
the controller is configured to limit, based on the information on the status, an area with which each of the one or more automated driving vehicles can be associated, or an operation diagram with which each of the one or more automated driving vehicles can be associated.

7. The information processing apparatus according to claim 1, wherein
information on each of the one or more operation diagrams includes information on a condition of the route of each of the one or more operation diagrams, and
the controller is configured to limit, based on the information on the condition of the route, an operation diagram with which each of the one or more automated driving vehicles can be associated.

8. The information processing apparatus according to claim 2, wherein the controller is configured to:
determine, based on information on an operation date contained in information on the one service, whether the one service is temporary; and
when the one service is determined as being temporary, display, on the built-in display or the screen of the external device, the one service in such a manner as to indicate that the one service is temporary.

9. The information processing apparatus according to claim 4, wherein
information on each of the one or more locations includes information on an autonomous driving development kit (ADK) compatible with each of the one or more locations, and
the controller is configured to limit, based on the information on the ADK, an area with which each of the one or more operation diagrams can be associated.

10. The information processing apparatus according to claim 4, wherein
information on each of the one or more locations includes information on an autonomous driving development kit (ADK) compatible with each of the one or more locations, and
the controller is configured to limit, based on the information on the ADK, arrangement of each of the one or more locations on a route of an operation diagram.

11. A method performed by an information processing apparatus configured to manage an operation plan for one or more automated driving vehicles, the method comprising:
storing, in a database, one or more users, the one or more automated driving vehicles, one or more operation diagrams, and one or more locations on a route in each of the one or more operation diagrams, in association with at least one area; and
displaying, for each of the one or more users, one or more operation diagrams associated with at least one area associated with the user, on a built-in display or a screen of an external device.

12. The method according to claim 11, further comprising:
storing each of the one or more operation diagrams in one-to-one association with one service, information on each of the one or more operation diagrams including an operation start time and an operation end time; and
performing control so that a first automated driving vehicle associated with a first operation diagram cannot be associated with a second operation diagram that partially overlaps the first operation diagram in time period.

13. The method according to claim 11, wherein
information on each of the one or more automated driving vehicles includes information on an autonomous driving development kit (ADK) installed in each of the one or more automated driving vehicles, and
the method further comprises limiting, based on the information on the ADK, an area with which each of the one or more automated driving vehicles can be associated, or an operation diagram with which each of the one or more automated driving vehicles can be associated.

14. The method according to claim 13, further comprising, when an area with which an automated driving vehicle is associated has been changed, outputting, to the built-in display or the screen of the external device, a message to encourage a change of a setting on the ADK of the automated driving vehicle.

15. The method according to claim 11, wherein information on each of the one or more automated driving vehicles includes information on a status of each of the one or more automated driving vehicles, and
the method comprises limiting, based on the information on the status, an area with which each of the one or more automated driving vehicles can be associated, or an operation diagram with which each of the one or more automated driving vehicles can be associated.

16. The method according to claim 11, wherein
information on each of the one or more operation diagrams includes information on a condition of the route of each of the one or more operation diagrams, and
the method further comprises limiting, based on the information on the condition of the route, an operation diagram with which each of the one or more automated driving vehicles can be associated.

17. The method according to claim 11, further comprising:
storing each of the one or more operation diagrams in one-to-one association with one service;
determining, based on information on an operation date contained in information on the one service, whether the one service is temporary; and
when the one service is determined as being temporary, displaying, on the built-in display or the screen of the external device, the one service in such a manner as to indicate that the one service is temporary.

18. The method according to claim 13, wherein
information on each of the one or more locations includes information on an autonomous driving development kit (ADK) compatible with each of the one or more locations, and
the method further comprises limiting, based on the information on the ADK, an area with which each of the one or more operation diagrams can be associated.

19. The method according to claim 13, wherein
information on each of the one or more locations includes information on an autonomous driving development kit (ADK) compatible with each of the one or more locations, and
the method further comprises limiting, based on the information on the ADK, arrangement of each of the one or more locations on a route of an operation diagram.

20. A system configured to manage an operation plan for one or more automated driving vehicles, the system comprising:
an information processing apparatus; and
a terminal apparatus,
wherein
the information processing apparatus includes a database configured to store one or more users, the one or more automated driving vehicles, one or more operation diagrams, and one or more locations on a route in each of the one or more operation diagrams, in association with at least one area, and
the information processing apparatus or the terminal apparatus is configured to display, on a screen, for each of the one or more users, one or more operation diagrams associated with at least one area associated with the user.
